(19) United States
(12) Patent Application Publication
(10) Pub. No.: US 2011/0055893 A1
(43) Pub. Date: Mar. 3, 2011

(54) COMMUNICATION APPLICATION

(76) Inventors: Jeffrey J. WALLS, Fort Collins, CO (US); Jerald C. FISHER, Fort Collins, CO (US); Karen E. THAYER, Fort Collins, CO (US); Byron A. ALCORN, Fort Collins, CO (US); Steven T. TEEPLES, Fort Collins, CO (US); Alan D. WARD, Fort Collins, CO (US)

(21) Appl. No.: 12/551,273

(22) Filed: Aug. 31, 2009

(51) Int. Cl. G06F 15/16; G06F 21/00

(52) U.S. Cl. 726/3; 709/228

(57) ABSTRACT

In at least some embodiments, a computer system includes a processor and a system memory coupled to the processor. The system memory stores a communication application that, when executed, provides first stage operations and second stage operations. The computer system also includes a network interface coupled to the processor. The first stage operations comprise a selective exchange of primary connection information with a communication endpoint via the network interface. The second stage operations comprise initiating a peer-to-peer communication session with the communication endpoint based on the primary connection information.

### BACKGROUND

One of the challenges for remote communications (e.g., videoconferencing) is session initiation. In order to initiate a session, a discovery process and then a connection process are generally needed. For example, a local user may initiate a communication session by discovering and connecting to a remote user. To facilitate the discovery and connection processes, various proprietary communication services enable users to set up an account. Such accounts typically enable each user to manage a contact list and to initiate a communication session with online users in their contact list. As the number of communication services that are available increase, the effort that will be needed by each user to manage different accounts with different contact lists also increases.

### BRIEF DESCRIPTION OF THE DRAWINGS

For a detailed description of exemplary embodiments of the invention, reference will now be made to the accompanying drawings in which:

FIG. 1 illustrates a system in accordance with embodiments of the disclosure;

FIG. 2 illustrates various software components of a communication application in accordance with an embodiment of the disclosure;

FIG. 3 illustrates various operations of a communication application in accordance with an embodiment of the disclosure;

FIG. 4 illustrates use of identifiers for a communication application in accordance with an embodiment of the disclosure;

FIG. 5 illustrates a communication technique between two endpoints in accordance with an embodiment of the disclosure; and

FIG. 6 illustrates a method in accordance with embodiments of the disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

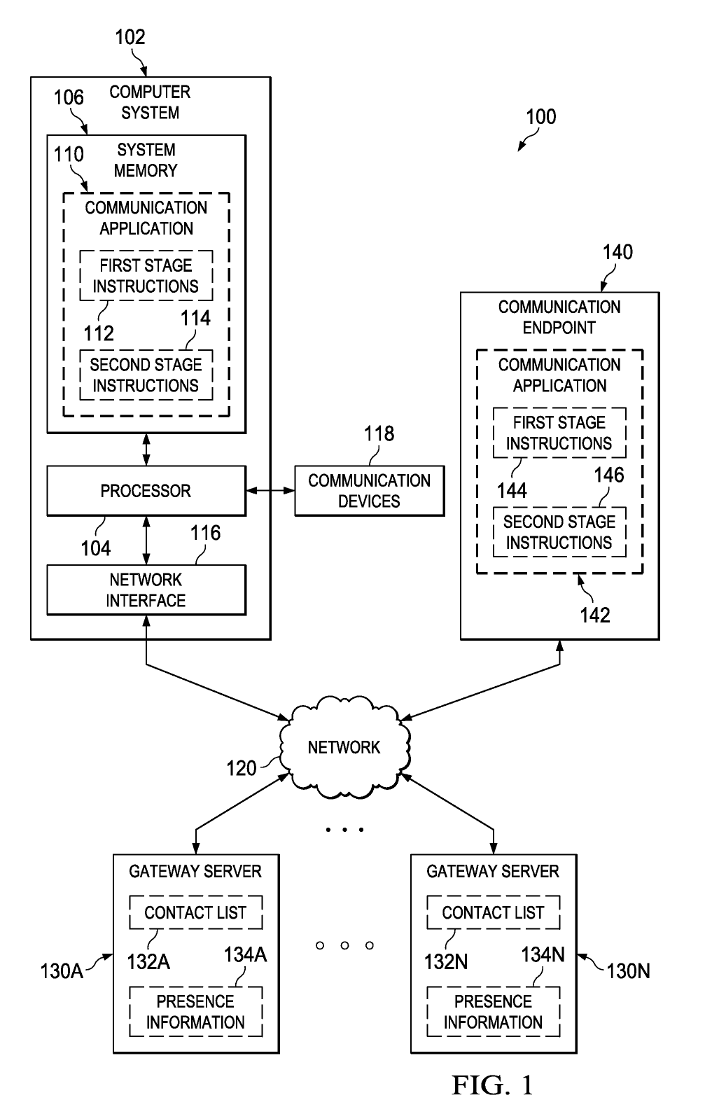

FIG. 1 illustrates a system 100 in accordance with embodiments of the disclosure. As shown in FIG. 1, the system 100 comprises a computer system 102 coupled to a communication endpoint 140 via a network 120. The computer system 102 is representative of a desktop computer, a laptop computer, a “netbook”, a smart phone, a personal digital assistant (PDA), or other electronic devices. Although only one communication endpoint 140 is shown, it should be understood that the computer system 102 may be coupled to a plurality of communication endpoints via the network 120. Further, it should be understood, that the computer system 102 is itself a communication endpoint. As used herein, a “communication endpoint” refers to an electronic device that is capable of running a communication application and supporting a peer-to-peer communication session.

In accordance with embodiments, the computer system 102 and communication endpoints (e.g., the communication endpoint 140) employ respective communication applications 110 and 142 to facilitate an efficient communication session. As shown, the communication application 110 comprises first stage instructions 112 and second stage instructions 114. Likewise, the communication application 142 comprises first stage instructions 144 and second stage instructions 146. Various operations related to the first and second stage instructions will later be described.

As shown in FIG. 1, the computer system 102 comprises a processor 104 coupled to a system memory 106 that stores the communication application 110. In accordance with embodiments, the processor 104 may correspond to at least one of a variety of semiconductor devices such as microprocessors, central processing units (CPUs), microcontrollers, main processing units (MPUs), digital signal processors (DSPs), advanced reduced instruction set computing (RISC) machines, ARM processors, application specific integrated circuits (ASICs), field programmable gate arrays (FPGAs) or other processing devices. In operation, the processor 104 performs a set of predetermined functions based on data/instructions stored in or accessible to the processor 104. In at least some embodiments, the processor 104 accesses the system memory 106 to obtain data/instructions for the predetermined operations. The system memory 106 is sometimes referred to as a computer-readable storage medium and may comprise volatile memory (e.g., Random Access Memory), non-volatile memory (e.g., a hard drive, a flash drive, an optical disk storage, etc.), or both.

To support a communication session, the computer system 102 comprises communication devices 118 coupled to the processor 104. The communication devices may be built-in devices and/or peripheral devices of the computer system 102. As an example, the communication devices 118 may correspond to various input devices and/or output devices such as a microphone, a video camera (e.g., a web-cam), speakers, a video monitor (e.g., a liquid crystal display), a keyboard, a keypad, a mouse, or other devices that provide a user interface for communications. Each communication endpoint (e.g., the communication endpoint 140) also may include such communication devices.

To enable remote communications with the network 120, the computer system 102 comprises a network interface 116 coupled to the processor 104. The network interface 116 may take the form of modems, modem banks, Ethernet cards, Universal Serial Bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, or other network interfaces. In conjunction with execution of the communication application 110 by the processor 104, the network interface 116 enables establishment and maintenance of a communication session between the computer system 102 and the communication endpoint 140.

In accordance with at least some embodiments, execution of the first stage instructions 112 causes a selective exchange of primary connection information between the computer system 102 and the communication endpoint 140. As used herein, “primary connection information” refers to the minimalist set of information that is needed to establish a peer-to-peer communication session between the computer system 102 and the communication endpoint 140. In some embodiments, the primary connection information comprises user identifiers associated with the communication applications 110 and 140 and internet protocol (IP) addresses of the computer system 102 and the communication endpoint 140. In other words, the computer system 102 receives the user identifier of a user logged into the communication application 142 and receives the IP address of the communication endpoint 140. On the other hand, the communication endpoint 140 receives the user identifier of a user logged into the communication application 110 and receives the IP address of the computer system 102.

In at least some embodiments, successful exchange of the primary connection information is dependent on prior user authentications performed at each of the computer system 102 and the communication endpoint 140. Such user authentication may be based on verification of username/password, biometrics, smartcard information and/or other identifiers. For example, successful user authentication at the computer system 102 results in a user having access to various features of the communication application 110 (i.e., the user is logged into the communication application 110) including a user interface that presents information to the user (e.g., via a display monitor).

With access to the user interface of the communication application 110, the user at the computer system 102 is able to request initiation of a peer-to-peer communication session with one or more users currently “online” at their respective communication endpoints. To detect a user's online status, the computer system 102 accesses information maintained by at least one of a plurality of gateway servers 130A-130N coupled to the network 120. As shown in the embodiment of FIG. 1, each of the gateway servers 130A-130N maintains a respective contact list 132A-132N and respective presence information 134A-134N related to users corresponding to each contact list 132A-132N. The presence information 134A-134N indicates whether a user is “online” and is accumulated by the gateway servers 130A-130N as users log into a service application provided by the gateway servers 130A-130A. In other words, the communication application 110 is able to indirectly populate its own contact list and presence information based on predetermined contact lists (e.g., the contact lists 132A-132N) and corresponding presence information (e.g., the presence information 134A-134N) maintained by gateway servers 130A-130N. Examples of the gateway servers 130A-130N include, but are not limited to, email servers, instant messaging servers, videoconference servers, or other communication service servers that maintain a contact list and presence information. Gmail®, Jabber®, and Office Communicator® are examples of communication services with corresponding servers that maintain contact lists and presence information. In some embodiments, the computer system 102 itself maintains a local contact list and presence information that is accessible by the communication application 110 for populating the contact list and presence information of the communication application 110.

In order to access a contact list and presence information maintained by a given gateway server, a user at the computer system 102 often logs into the communication service provided by the given gateway server. Although the user could log into each gateway server communication service separately, some embodiments of the communication application 110 enable management of the login process for all gateway service accounts associated with the user of the computer system 102. For example, when a user successfully logs into the communication application 110, all gateway server accounts associated with the user are automatically activated (e.g., by completing a login process for each gateway server account). Alternatively, a user at the computer system 102 may select a default sub-set of gateway server accounts to be activated upon a successful login process for the communication application 110. In either case, the communication application 110 facilitates the selection of individuals to participate in a communication session by populating a contact list (sometimes referred to as a “buddy list”) from predetermined contact lists (e.g., contact lists 132A-132N) maintained by at least one of the gateway servers 130A-130N. The communication application 110 also maintains presence information for the populated contact list based on predetermined presence information (e.g., presence information 134A-134N) maintained by at least one of the gateway servers 130A-130N. The communication application 110 also may maintain primary connection information for each contact in the populated contact list.

In accordance with at least some embodiments, another feature of the communication application 110 is the ability to update the contact lists 132A-132N maintained by the gateway servers 130A-130N. In other words, the communication application 110 is able to receive local updates to the populated contact list (e.g., based on user input) of the communication application 110 and is able to sync those updates with the contact lists 132A-132N maintained by the gateway servers 130A-130N. Each sync update may be universal in scope (affecting all gateway server accounts related to the communication application 110), individualized (affecting one of a plurality of gateway server accounts related to the communication application 110), or customized (affecting a sub-set of a plurality of gateway server accounts related to the communication application 110). To accomplish the sync function, contact list update commands compatible with each gateway server account are maintained by the communication application 110. As needed, such commands are executed by the communication application 110. It should be understood that sync updates are possible once access to each gateway server account has been obtained (e.g., based on a successful login process or other user authentication technique) and that the sync updates rely on pre-existing contact list update commands available for each gateway server account.

To initiate a communication session, a user at the computer system 102 selects an online user from the populated contact list of the communication application 110. The communication session is initiated based on primary connection information that is selectively exchanged between the computer system 102 and communication endpoints (e.g., the communication endpoint 140). In some embodiments, the primary connection information is embedded into communication packets (e.g., presence information packets) corresponding to a gateway server communication service provided by at least one of the gateway servers 130A-1 30N. In other words, once a user has logged into the communication application 110 and subsequently logged into gateway server accounts related to the communication application 110, the exchange of primary connection information between the computer system 102 and communication endpoints is facilitated by embedding the primary connection information into communication packets (e.g., presence information packets) exchanged as part of a gateway server communication service protocol. In some cases, there may be more than gateway server communication service available to exchange primary connection information since the user of the computer system 102 and the selected online user may be logged into multiple gateway server accounts at the same time. Regardless of the number of available gateway server communication services that are used, the communication application 110 may collect and, as needed, update primary connection information for all contacts in a buddy list associated with the communication application 110. The communication application 110 also may broadcast the primary connection information of the user logged into the communication application 110 to other communication endpoints in the same manner (i.e., via an available gateway server communication service).

As needed, the primary connection information is utilized to establish a peer-to-peer communication session between the computer system 102 and the communication endpoint of the selected online user. Although the selected online user may be at any of a plurality of communication endpoints coupled to the network 120, the discussion herein assumes the selected online user is at the communication endpoint 140. In accordance with embodiments, the communication endpoint 140 is compatible with the communication application 110 due to its execution of the communication application 142. By executing the communication application 142, the primary connection information transmitted by the computer system 102 is detected and extracted from at least one communication packet related to the gateway server communication service being used. Although not required, it should be understood that each gateway server communication service may implement its own protocol. Regardless of the particular protocol associated with a gateway server communication service, the primary connection information may be embedded into at least one communication packet by filling unused spaces within the communication packets of the gateway server communication service being used. Such unused spaces are common and can be determined by reference to the protocol/specification corresponding to each gateway server communication service.

As an example, for Extensible Messaging and Presence Protocol (XMPP) or Jabber communication services, the primary connection information may be transmitted to a communication endpoint by populating an option status field with an XML string that contains the primary connection information. Alternatively, an optional <empty> field in the XMPP presence protocol or possibly the Publish/Subscribe XMPP protocol may be used to transmit the primary connection information. For Office Communicator Server (OCS) communication services, the primary connection information may be transmitted to a communication endpoint by populating a user definable field (e.g., Endpoint Location) with an XML string that contains the primary connection information.

Upon reception of communication packets having the primary connection information, the communication application 142 of the communication endpoint 140 causes extraction of the primary connection information. The extraction operation is supported by execution of the first stage instructions 144 of the communication application 142. With the primary connection information, the communication applications 110 and 142 enable the users of the computer system 102 and the communication endpoint 140 to selectively participate in begin a communication session. For example, each user may accept or reject an invitation by the other to participate in a communication session.

In some embodiments, if a selected online user rejects an invitation to participate in a communication session, the first stage instructions 144 either cause the communication endpoint 140 to transmit a negative response back to the computer system 102 (e.g., using the same gateway server communication service that was used to make the initial request), to ignore the invitation, or to otherwise reject the invitation. In such case, the computer system 102 is unable to start a peer-to-peer communication session with the communication endpoint 140.

If the selected online user accepts an invitation to participate in a communication session, a peer-to-peer communication session between the computer system 102 and the communication endpoint 140 is established based on the primary connection information. In accordance with at least some embodiments, successful establishment of the peer-to-peer communication session causes the communication applications 110 and 142 to transition from execution of the first stage instructions 112 and 144 to execution of the second stage instructions 114 and 146.

In at least some embodiments, the second stage instructions 114 and 146 cause supplemental connection information used during the peer-to-peer communication session to be exchanged between the computer system 102 and the communication endpoint 140. This exchange of supplemental connection information occurs after the peer-to-peer communication session between the computer system 102 and the communication endpoint 140 has been initiated. As used herein, “supplemental connection information” refers to information and/or parameters that facilitate a communication technique, but that are not necessary for initiation of a communication session. As an example, in an embodiment where the communication session corresponds to a teleconference, the supplemental connection information comprises audio/video codecs. Additionally or alternatively, the supplemental information may comprise, for example, screen resolution, encryption methodology, and/or network port negotiation. In alternative embodiments, the communication session may correspond to a peer-to-peer desktop sharing session. In such case, supplemental information may comprise, for example, screen resolution, encryption methodology, and/or network port negotiation.

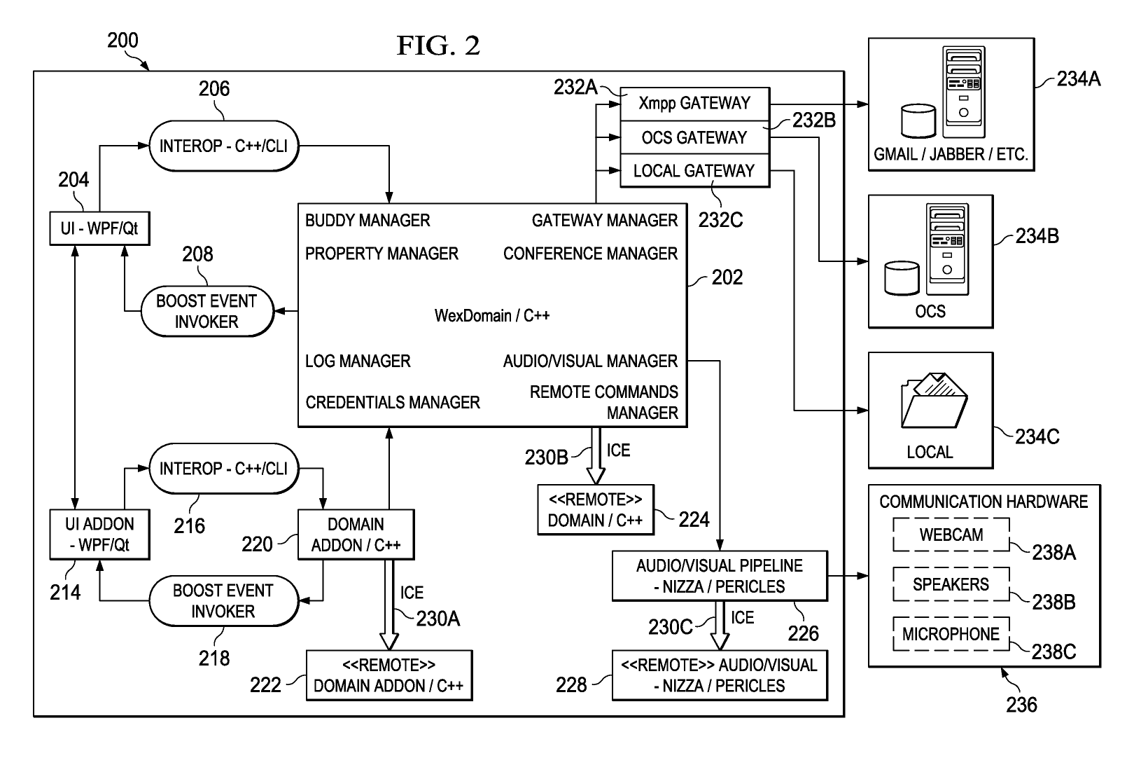

FIG. 2 illustrates various software components of a communication application 200 in accordance with an embodiment of the disclosure. The communication application 200 may correspond, for example, to either of the communication applications 110 and 142 of FIG. 1. As shown, the communication application 200 comprises a management module 202 that supports various management functions of the communication application 200. The management module 202 may be programmed using WexDomain. As shown, the management module 202 supports a “Buddy Manager”, a “Property Manager”, a “Log Manager”, a “Credentials Manager”, a “Gateway Manager”, a “Conference Manager”, an “AudioNideo (AN) Manager”, and a “Remote Command Manager.”

The Buddy Manager of the management module 202 maintains a contact list for the communication application 200. The Property Manager of the management module 202 enables administrative modification of various internal properties of the communication application 200 such as communication bandwidth or other properties. The Gateway Manager of the management module 202 provides an interface for the communication application 200 to communicate with gateway servers 254A-254C. As shown, there may be individual interfaces 232A-232C corresponding to different gateway servers 254A-254C since each gateway server may implement a different protocol. Examples of the interfaces 232A-232C include, but are not limited to, an XMPP interface, an OCS interface, and a local interface.

Meanwhile, the Conference Manager of the management module 202 handles communication session features such as session initiation, time-outs, or other features. The Log Manager of the management module 202 is a debug feature for the communication application. The Credentials Manager of the management module 202 handles login information (e.g., username, password) related to the gateway servers 254A-254C so that an automated login process to the gateway servers 254A-254C is provided by the communication application 200. The A/V Manager of the management module 202 sets up an ANV pipeline to support the communication session. The Remote Commands Manager of the management module 202 provides remoting commands that enable the communication endpoint (e.g., the computer system 102) that implements the communication application 200 to send information to and receive information from a remote computer.

As shown, the management module 202 interacts with various other software modules. In at least some embodiments, the management module 202 sends information to and receives information from a user interface (UI) module 204. The UI module 204 may be based on, for example, Windows Presentation Foundation (WPF) or “Qt” software. In the embodiment of FIG. 2, the management module 202 sends information to the UI module 204 using a “boost” event invoker 208. As used herein, “boost” refers to a set of C++ libraries that can be used in code. On the other hand, the UI module 204 sends information to the management module 202 using a C++ interop or Command Language Intrastructure (CLI) interop. The management module 202 also interacts with a <<remote>> domain module 224 that uses remote commands of the Remote Command Manager of the management module 202 to initiate and carry out a communication session with a remote computer. To carry out the communication session, the management module 202 interacts with an A/V pipeline module 226. In at least some embodiments, the A/V pipeline module 226 is based on Nizza/Pericles software. In operation, the A/V pipeline module 226 discovers, configures (e.g., codec parameters), and sends information to or receives information from communication hardware 236. Examples of communication hardware 236, include but are not limited to, web-cams 238A, speakers 238B and microphones 238C. The communication application 200 also comprises a <<remote>> A/V module 228 that interacts with the A/V pipeline 226 to extend some or all of the functions of the A/V pipeline 226 to a remote computer. As shown, all of the remoting commands (e.g., commands to the <<remote>> domain module 224, commands to the <<remote>> domain addon module 222, commands to the <<remote>> AN module 228) may be based on Internet Communications Engine (ICE) commands 230A-230C.

In the embodiment of FIG. 2, the UI module 204 and the management module 202 selectively interact with a UI addon module 214, a domain addon module 220 and a <<remote>> domain addon module 222. In accordance with at least some embodiments, the “addon” modules (214, 220 and 222) extend the features of the communication application 200 for remote use without changing the core code. As an example, the addon modules 214, 220 and 222 may correspond to a “desktop sharing” feature that provides the functionality of the communication application 200 at a remote computer. More specifically, the UI addon module 214 provides some or all of the functions of the UI module 204 for use by a remote computer. Meanwhile, the domain addon module 220 provides some or all of the functions of the management module 202 for use by a remote computer. Meanwhile, the <<remote>> domain addon module 222 provides some or all of the functions of the <<remote>> domain module 224 for use by a remote computer. As shown, just as the management module 202 and the UI module 204 interact using interops 206 and boost event invokers 208, the domain addon module 220 and the UI addon module 214 may interact using interops 216 and boost event invokers 218.

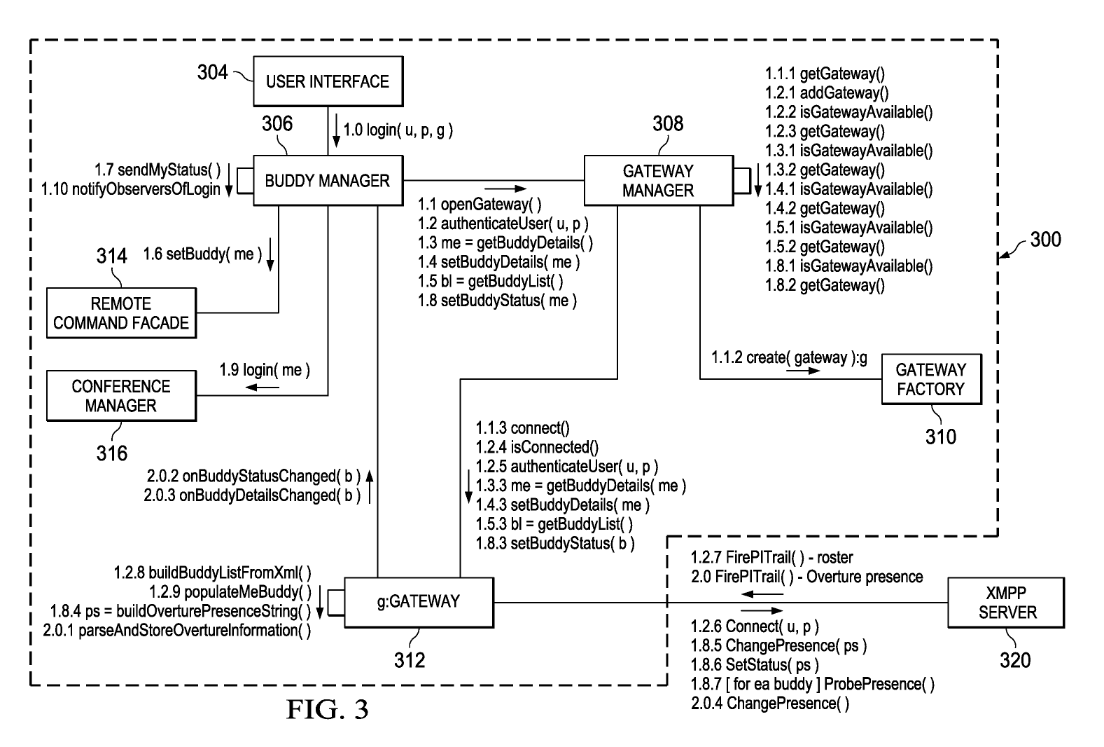

FIG. 3 illustrates various operations of a communication application 300 in accordance with embodiments of the disclosure. The communication application 300 may correspond, for example, to either of the communication applications 110 and 142 of FIG. 1. Also, the communication application 300 may correspond to the communication application 200 of FIG. 2. In FIG. 3, the communication application 300 comprises various software components that interact with each other.

As shown, the communication application 300 comprises a user interface component (“UI”) 304 in communication with a buddy manager component 306. The UI component 304 supports a login operation (step 1.0) to enable a user to access the buddy manager component 306. Once the buddy manager component 308 has been accessed, various other components are accessible including a gateway manager component 308, a conference manager component 316, and a remote command facade component 314. In at least some embodiments, the buddy manager component 306 issues an “open gateway” command (step 1.1) to the gateway manager component 308. In response, the gateway manager component 308 performs a “get gateway” command (step 1.1.1) related to a particular gateway. If the particular gateway is not yet set up for use with the communication application 302, the “get gateway” command causes the gateway manager component 308 to issue a “create gateway” command (step 1.1.2) to a gateway factory component 310. The gateway factory component 310 manages the information and processes needed to establish a new gateway for the communication application 302. If a gateway has already been set up for the communication application 302, the “get gateway” command causes the gateway manager component 308 to issue a “connect” command (step 1.1.3) to a gateway component 312 for connecting the communication application 302 to a gateway server 320 (e.g., an Xmpp server).

In at least some embodiments, connection to a gateway server account provided by the gateway server 320 requires user authentication. In such cases, the buddy manager component 306 issues an “authenticate user” command (step 1.2) to the gateway manager component 308. The gateway manager component 308 then performs several commands including an “add gateway” command (step 1.2.1), an “is gateway available” command (step 1.2.2) and a “get gateway” command (1.2.3). If the gateway server 320 is available as determined by steps 1.2.2 and 1.2.3, the gateway manager component 308 issues an “is connected” notification (step 1.2.4) and an “authenticate user” command (step 1.2.5) to the gateway component 312. The gateway component 312 issues a “connect” command (step 1.2.6) to connect to the gateway server 320. In response to the connect command, the gateway server 320 provides a roster (step 1.2.7) to the gateway component 312. Based on the roster, the gateway component 312 performs a “build buddy list” command (step 1.2.8) and populates a particular buddy list corresponding to the user logged into the communication application 300.

As needed, the buddy manager component 306 issues a “get buddy details” command (step 1.3) to the gateway manager component 308. In response, the gateway manager component 308 performs several commands including an “is gateway available” command (step 1.3.1) and a “get gateway” command (step 1.3.2). If the gateway server 320 is available as determined by steps 1.3.1 and 1.3.2, the gateway manager component 308 issues a “get buddy details” command (step 1.3.3) to the gateway component 312. In response, the gateway component 312 provides buddy details based on the populated buddy list maintained by the gateway component 312. Examples of buddy details include, but are not limited to, a name, an email address, a picture (avatar), or other personal information.

In at least some embodiments, a user is able to update the populated buddy list maintained at the gateway component 312. To update the populated buddy list, the buddy manager component 306 issues a “set buddy details” commands (step 1.4) to the gateway manager component 308. In response, the gateway manager component 308 performs several commands including an “is gateway available” command (step 1.4.1) and a “get gateway” command (step 1.4.2). If the gateway server 320 is available as determined by steps 1.4.1 and 1.4.2, the gateway manager component 308 issues the “set buddy details” command (step 1.4.3) to the gateway component 312. In response, the gateway component 312 sets buddy details in the populated buddy list maintained by the gateway component 312. As previously mentioned, examples of buddy details include, but are not limited to, a name, an email address, a picture (avatar), or other personal information. In accordance with at least some embodiments, the “get buddy details” command and the “set buddy details” command enables a user of the communication application 300 to view and update his/her own personal information. Additionally, the “get buddy details” command may be used to view the personal information of someone in the populated contact list. In some embodiments, the populated contact list only displays abbreviated information (e.g., a username) unless additional information is requested using the “get buddy details” command or the “set buddy details” command.

The buddy manager component 306 may also issue a “get buddy list” command (step 1.5) to the gateway manager component 308. In response, the gateway manager component 308 performs several commands including an “is gateway available” command (step 1.5.1) and a “get gateway” command (step 1.5.2). If the gateway server 320 is available as determined by steps 1.5.1 and 1.5.2, the gateway manager component 308 issues the “get buddy list” command (step 1.5.3) to the gateway component 312. In response, the gateway component 312 obtains the buddy list associated with the authenticated user from the gateway server 320. If there are multiple gateway servers, the “get buddy list” command may result in a consolidated and sorted buddy list obtained from multiple gateway servers.

At step 1.6, the buddy manager component 306 issues a “set buddy” command to the remote command facade component 314. At step 1.7, the buddy manager component 306 performs a “send my status” command to notify the gateway server 320 regarding the online status of the user logged into the communication application 300. The communication application 300 also needs to track the online status of the contacts in the populated buddy list. To accomplish this, the buddy manager component 306 issues a “set buddy status” command (step 1.8) to the gateway manager component 308. In response, the gateway manager component 308 performs several commands including an “is gateway available” command (step 1.8.1) and a “get gateway” command (step 1.8.2). If the gateway server 320 is available as determined by steps 1.8.1 and 1.8.2, the gateway manager component 308 issues the “set buddy status command (step 1.8.3) to the gateway component 312. In response, the gateway component 312 performs a “build Overture presence string” command (step 1.8.4) to broadcast and receive primary connection information (e.g., an XML string) in communication packets of a gateway server communication service associated with the gateway server 320. As used herein, “Overture” refers to the name of the communication application 300. The exchange of primary connection information is performed by the gateway component 312 issuing various commands to the gateway server 320. Specifically, the gateway component 312 may issue a “change presence” command (step 1.8.5) and a “set status” command (step 1.8.6) to broadcast primary connection information to online users via the gateway server 320. Further, the gateway component 312 may issue a “probe presence” command (step 1.8.7) to gateway server 320 collect primary connection information for each contact in the populated buddy list.

At step 1.9, the buddy manager component 306 issues a login command to the conference manager component 316. The buddy manager component 306 then performs a “notify observers of login” command (step 1.10). Steps 1.9 and 1.10 enable a user to invite at least one online user in the populated buddy list to participate in a communication session.

Periodically, the gateway server 320 provides “Overture presence” information to the gateway component 312 (step 2.0). In response, the gateway component 312 performs a “parse and store Overture information” command (step 2.0.1). With the overture information from the gateway server 320 parsed and stored, the gateway component 312 is able to issue a “buddy status changed” command (step 2.0.2) and a “buddy details changed” command (step 2.0.3) to the buddy manager component 306. As needed, the gateway component 312 may issue a “change presence” command (step 2.0.4) to the gateway server 320 to notify the gateway server 320 if the user of the communication application 300 logs out or otherwise changes his/her online status. Step 2.0 (including steps 2.0.1-2.0.4) enables users to periodically update presence information as well as primary connection information for use by the communication application 300.

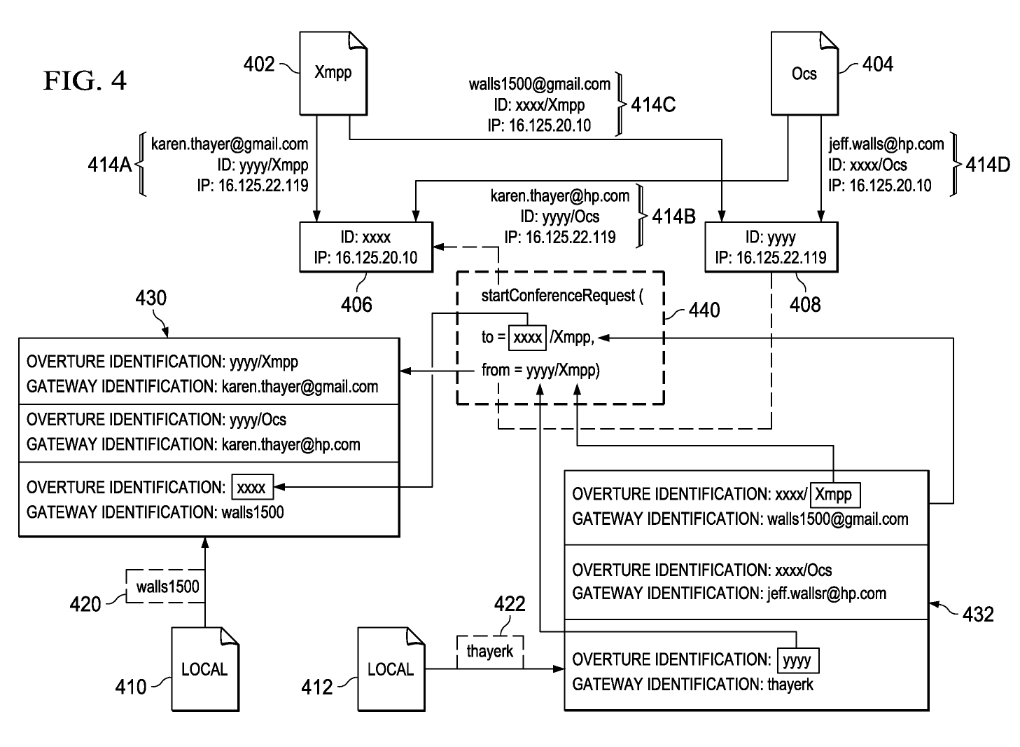

FIG. 4 illustrates use of identifiers for a communication application in accordance with an embodiment of the disclosure. In the embodiment of FIG. 4, blocks 406 and 408 correspond to primary connection information as described herein. The information in blocks 406 and 408 are obtained from gateway servers 402 and 404. As an example, the gateway server 402 corresponds to a XMPP server and the gateway server 404 corresponds to an OCS server. The primary connect information may be provided by either of the gateway servers 402 and 404. In other words, the primary connection information in blocks 406 and 408 is based on communication packets 414A and 414C obtained from the gateway server 402. Alternatively, the primary connection information in blocks 406 and 408 is based on communication packets 414B and 414B obtained from the gateway server 404.

The primary connection information is used to formulate a “start conference request” 440 that is based on the IP addresses of the endpoints involved and the usernames of users logged into the respective communication applications. In accordance with embodiments, issuance of the start conference request 440 is based on a gateway server communication service provided by one of the gateway servers 402 and 404. As an example, FIG. 4 shows issuance of the start conference request 440 based on an XMPP service provided by the gateway server 402. FIG. 4 also shows that some information for the start conference request 440 may be obtained from local servers 410 and 412. In accordance with at least some embodiments, each communication endpoint that participates in a communication session is able to compile information to facilitate the start conference request 440. For example, in FIG. 4, a select username related to a communication application (referred to as “Overture” herein) and a select gateway server communication service for use with the start conference request 440 are obtained from compiled lists 430 and 432.

In summary, each of the communication applications described herein (e.g., communication applications 110, 142, 200, 302) may correspond to an application that is stored on a computer-readable medium. When executed by a processor, a communication application causes a processor to selectively exchange primary connection information of a computer system and a communication endpoint via a network interface. In at least some embodiments, the exchange of primary connection information is limited to user identifiers associated with the communication application and internet protocol (IP) addresses. In at least some embodiments, a communication application further causes a processor to initiate a peer-to-peer communication session with the communication endpoint based on the primary connection information. A communication application, when executed, may further cause the processor to perform a user authentication process at the computer system and, if the user authentication process results in successful user authentication, to exchange the primary connection information. A communication application, when executed, may further cause the processor to populate a contact list and to maintain contact availability information based on predetermined contact list information and predetermined contact availability information maintained by at least one gateway server coupled to the network interface. A communication application, when executed, may further cause the processor to exchange audio codes or video codes between the computer system and the communication endpoint after the peer-to-peer communication session has been initiated. A communication application, when executed, may further cause the processor to maintain a single contact list based on a plurality of contact lists accessible via at least one gateway server coupled to the network interface.

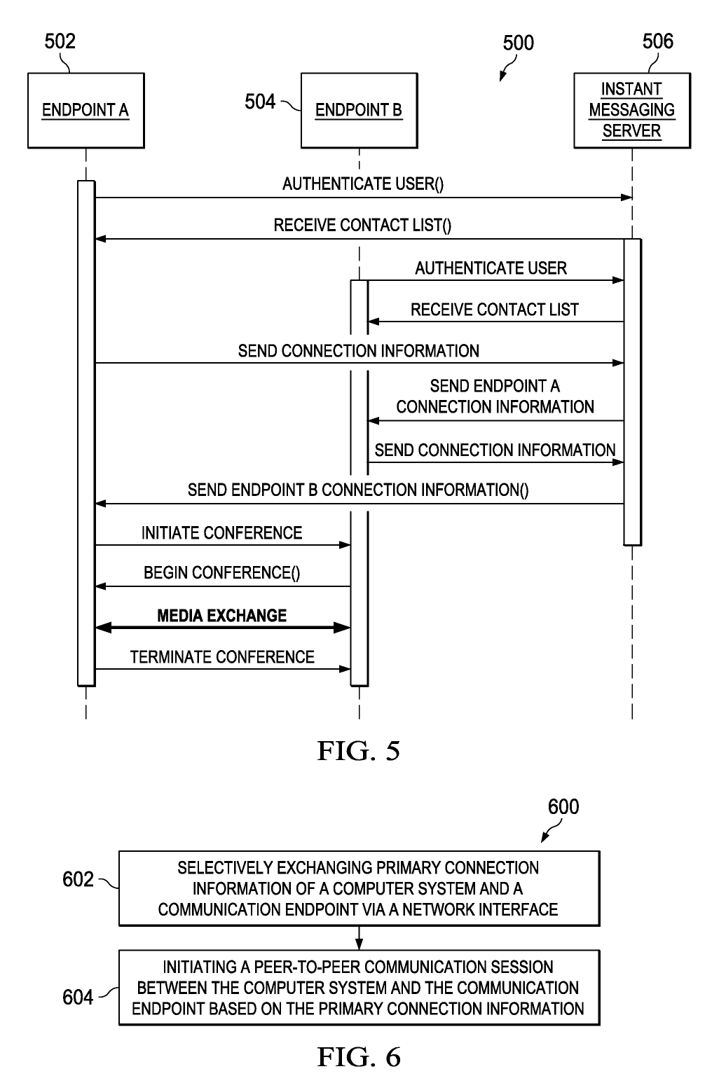

FIG. 5 illustrates a communication technique 500 between two endpoints in accordance with an embodiment of the disclosure. In FIG. 5, the steps begin chronologically at the top (nearest the blocks representing endpoints 502, 504 and instant messaging (IM) server 506) and proceed downward. As shown, the IM server 506 authenticates a user of the endpoint A 502. In response, the endpoint A 502 receives a contact list from the IM server 506. Next, the IM server 506 authenticates a user of the endpoint B 504. In response, the endpoint B 504 receives a contact list from the IM server 506. Based on the contact list from the IM server 506, endpoint A 502 sends connection information to the IM server 506, which forwards endpoint A connection information to the endpoint B 504. Similarly, endpoint B 504 sends connection information to the IM server 506, which forwards endpoint B connection information to the endpoint A 502. In other words, the endpoint A 502 and the endpoint B 504 exchange primary connection information via the IM server 506. Subsequently, the endpoint A 502 is able to initiate a conference with endpoint B 504. Upon a successful response from the endpoint B 504 (i.e., a user of endpoint B 504 accepts a request to participate in a communication session with a user of endpoint A 502), a media exchange occurs. The media exchange may be audio, video, still images, text and/or media. Eventually, the conference terminates.

FIG. 6 illustrates a method 600 in accordance with embodiments of the disclosure. In accordance with embodiments, the method 600 is a computer-implemented method. As shown, the method 600 comprises selectively exchanging primary connection information of a computer system and a communication endpoint via a network interface (block 602). In at least some embodiments, the primary connection information is limited to user identifiers associated with a communication application and internet protocol (IP) addresses. The method 600 also comprises initiating a peer-to-peer communication session between the computer system and the communication endpoint based on the primary connection information (block 604).

The method 600 may comprise additional steps that are added individually or in combination. As an example, the method 600 may additionally comprise performing a user authentication process at the computer system and, if the user authentication process results in successful user authentication, then exchanging said primary connection information. The method 600 may additionally comprise maintaining a single contact list based on a plurality of contact lists accessible via at least one gateway server coupled to the network interface. The method 600 may additionally comprise exchanging supplemental connection information between the computer system and the communication endpoint after the communication session has been initiated based on the primary connection information. The supplemental information may be audio/video codecs or other information that facilitates communication, but is not required to establish a peer-to-peer communication session.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer system, comprising:
a processor;
a system memory coupled to the processor, the system memory storing a communication application that, when executed, provides first stage operations and second stage operations; and
a network interface coupled to the processor,
wherein the first stage operations comprise a selective exchange of primary connection information with a communication endpoint via the network interface,
wherein the second stage operations comprise initiating a peer-to-peer communication session with the communication endpoint based on the primary connection information.

2. The computer system of claim 1 wherein said selective exchange of primary connection information is based on a user authentication performed at the computer system.

3. The computer system of claim 2 wherein successful user authentication provides access to a user interface of the communication application.

4. The computer system of claim 3 wherein, when executed, the communication application populates a contact list and maintains contact availability information based on predetermined contact list information and predetermined contact availability information maintained by at least one gateway server coupled to the network interface.

5. The computer system of claim 4 wherein a user is able to submit changes for a contact list maintained by the at least one gateway server via the user interface of the communication application.

6. The computer system of claim 1 wherein said exchange of primary connection information is limited to exchanging user identifiers associated with the communication application and internet protocol (IP) addresses.

7. The computer system of claim 6 wherein supplemental connection information used during the communication session are exchanged between the computer system and the communication endpoint after the peer-to-peer communication session has been initiated.

8. The computer system of claim 7 wherein the supplemental connection information comprises audio/video codecs.

9. The computer system of claim 1 wherein the communication application maintains a single contact list based on a plurality of contact lists accessible via at least one gateway server coupled to the network interface.

10. A computer-readable storage medium storing a communication application that, when executed, causes a processor to:
selectively exchange primary connection information of a computer system and a communication endpoint via a network interface; and
initiate a peer-to-peer communication session with the communication endpoint based on the primary connection information.

11. The computer-readable storage medium of claim 10 wherein the communication application, when executed, causes the processor to perform a user authentication process at the computer system and, if the user authentication process results in successful user authentication, to exchange the primary connection information.

12. The computer-readable storage medium of claim 10 wherein the communication application, when executed, causes the processor to populate a contact list and to maintain contact availability information based on predetermined contact list information and predetermined contact availability information maintained by at least one gateway server coupled to the network interface.

13. The computer-readable storage medium of claim 10 wherein the exchange of primary connection information is limited to user identifiers associated with the communication application and internet protocol (IP) addresses.

14. The computer-readable storage medium of claim 10 wherein the communication application, when executed, causes the processor to exchange audio/video codecs between the computer system and the communication endpoint after the peer-to-peer communication session has been initiated.

15. The computer-readable storage medium of claim 10 wherein the communication application, when executed, causes the processor to maintain a single contact list based on a plurality of contact lists accessible via at least one gateway server coupled to the network interface.

16. A method, comprising:
selectively exchanging primary connection information of a computer system and a communication endpoint via a network interface; and
initiating a peer-to-peer communication session between the computer system and the communication endpoint based on the primary connection information.

17. The method of claim 16 further comprising performing a user authentication process at the computer system and, if the user authentication process results in successful user authentication, then exchanging said primary connection information.

18. The method of claim 16 further comprising maintaining a single contact list based on a plurality of contact lists accessible via at least one gateway server coupled to the network interface.

19. The method of claim 16 wherein the primary connection information is limited to user identifiers associated with a communication application and internet protocol (IP) addresses.

20. The method of claim 16 further comprising exchanging supplemental connection information between the computer system and the communication endpoint after the communication session has been initiated based on the primary connection information.
